(19) United States
(12) Patent Application Publication
(10) Pub. No.: US 2026/0292438 A1
(43) Pub. Date: Sep. 24, 2026

(54) METHOD AND APPARATUS FOR SENSING

(71) Applicant: Huawei Technologies Co., Ltd., Shenzhen (CN)

(72) Inventors: Alireza Bayesteh, Brossard (CA); Ahmed Wagdy Abdelwahab Shaban, Kanata (CA); Shahram Shahsavari, Ottawa (CA); Jianglei Ma, Ottawa (CA)

(21) Appl. No.: 19/453,622

(22) Filed: Jan. 20, 2026

Related U.S. Application Data
(63) Continuation of application No. PCT/CN2024/076266, filed on Feb. 6, 2024.
(60) Provisional application No. 63/514,856, filed on Jul. 21, 2023.

(51) Int. Cl. H04W 4/02; G01S 7/00

(52) U.S. Cl. CPC H04W 4/02; G01S 7/006

(57) ABSTRACT

Embodiments of the present application provide a method and an apparatus for sensing. In the present application, at least one sensing-related identity (e.g. TXSeN_{ID}, RXSeN_{ID}, or SeS_{ID}) can be embedded into a feedback signal by scrambling. The scrambling enables separation of sensing feedback signals without increasing the sensing feedback payload size.

### CROSS-REFERENCE TO RELATED APPLICATIONS

The present application is a continuation of International Patent Application PCT/CN2024/076266, entitled “Method and Apparatus for Sensing,” filed on Feb. 6, 2024, and claims the benefit of U.S. Patent Application No. 63/514,856, entitled “Methods, Apparatus, and Systems for Sensing Feedback and Reporting,” filed on Jul. 21, 2023.

The entire contents of the aforementioned applications are hereby incorporated by reference.

### TECHNICAL FIELD

Embodiments of the present invention relate to the field of communications technologies, and more specifically, to a method and apparatus for sensing.

### BACKGROUND

User equipment (UE) position information is often used in cellular communication networks to improve various performance metrics for the networks. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position,” and these two terms may be used interchangeably herein. Examples of well-known sensing systems include Radio Detection and Ranging (RADAR) sensing systems and Light Detection and Ranging (LIDAR) sensing systems. While the sensing system can be separated from the communication system, it could be advantageous to gather the information using an integrated system, which reduces the amount of hardware (and cost) in the system as well as the time, frequency, or spatial resources needed to achieve both functionalities. However, using the communication system hardware to perform sensing of UE pose and environment information is a highly challenging and open problem. The problem relates to factors such as the limited resolution of the communication system, the dynamicity of the environment, and the huge number of sensing targets whose electromagnetic properties and position are to be estimated.

Accordingly, integrated sensing and communication (also known as integrated communication and sensing, joint sensing and communication, and other similar names) is a desirable feature in existing and future communication systems.

In integrated sensing and communication (ISAC) networks, a sensing transmit (TX) node may transmit a sensing signal, one or more sensing receive (RX) nodes may receive the sensing signal and then each sensing RX node estimates sensing parameters of a sensing target based on the sensing signal, and then each sensing RX node may transmit a feedback signal which carries a sensing feedback content indicating the sensing parameters. Sensing parameters types and/or sensing parameters values may be different for different sensing RX nodes. Through these operations, a sensing measurement of the sensing target is achieved.

In integrated sensing and communication (ISAC) networks, various types of nodes may perform various sensing tasks, which results in a large number of feedback signals being transmitted in the networks. The large number of feedback signals will incur lots of sensing overhead which may need to be addressed.

### SUMMARY

Embodiments of the present application provide a method and apparatus for sensing, which can reduce the overhead for transmitting feedback signals.

According to a first aspect, an embodiment of the present application provides a method for sensing, and the method could be performed by a first sensing node. Unless otherwise specified, the first sensing node may refer to the first sensing node itself or an apparatus that supports the function of the first sensing node.

The method includes: receiving, by the first sensing node, a sensing feedback configuration from a second sensing node or another node responsible for coordinating sensing activities, where the sensing feedback configuration is used to generate a feedback signal; receiving, by the first sensing node, a sensing signal from a second sensing node; estimating, by the first sensing node, sensing parameters based on the sensing signal, where the sensing parameters indicate properties of a sensing target; generating, by the first sensing node, feedback signal based on the sensing feedback configuration and the sensing parameters, where the feedback signal carries a sensing feedback content which indicates the sensing parameters, at least one identity is embedded in the feedback signal by scrambling; and transmitting, by the first sensing node, the feedback signal.

According to the method above, the at least one identity can be embedded into the feedback signal by scrambling. The scrambling enables efficient separation of sensing feedback signals without increasing the sensing feedback payload size. Therefore, the method can reduce the overhead for transmitting feedback signals.

With reference to the first aspect, in an embodiment, the at least one identity comprises at least one of the following: an identity of the first sensing node, an identity of the second sensing node and an identity of a sensing session for estimating the sensing parameters.

In this implementation, one or more sensing-related identities are embedded in the feedback signal by scrambling, which can effectively distinguish feedback signals without increasing feedback overhead.

With reference to the first aspect or any one of the embodiments, in another embodiment, the sensing feedback configuration includes a first mapping between a sensing feedback codeword and the at least one identity, the sensing feedback codeword is used to carry the sensing feedback content, and the feedback signal is based on the sensing feedback codeword.

With reference to the first aspect or any one of the embodiments, in another embodiment, the first mapping includes a mapping between scrambling parameters and the at least one identity, where the scrambling parameters are used to scramble the sensing feedback content to obtain the sensing feedback codeword.

With reference to the first aspect or any one of the embodiments, in another embodiment, the sensing feedback configuration further includes at least one of the following information: a format of the sensing feedback content, a resource for transmitting the feedback signal, or a sensing feedback codebook including the sensing feedback codeword.

With reference to the first aspect or any one of the embodiments, in another embodiment, the format of the sensing feedback content is in binary format, in discrete format or in analog format, and/or the sensing feedback codebook is defined in digital domain or in analog domain.

With reference to the first aspect or any one of the embodiments, in another embodiment, generating the feedback signal based on the sensing feedback configuration and the sensing parameters includes: converting, by the first sensing node, the at least one identity into at least one scrambling sequence, where the at least one scrambling sequence is in one-to-one correspondence with the at least one identity; obtaining, by the first sensing node, the sensing feedback content based on the sensing parameters; scrambling, by the first sensing node, the sensing feedback content with the at least one scrambling sequence to obtain a sensing feedback codeword; and generating, by the first sensing node, the feedback signal based on the sensing feedback codeword.

In this implementation, the scrambling is implemented based on a bit-level scrambling with at least one scrambling sequence of the at least one ID, which supports a digital domain sensing feedback codebook scenario.

With reference to the first aspect or any one of the embodiments, in another embodiment, the sensing feedback configuration includes at least one of the following information: a quantization function used to convert the sensing parameters in analog format to the sensing feedback content in digital format, a length of the sensing feedback content, information of a forward error correction (FEC) used to encode the sensing feedback content, or one or more binary functions used to obtain the at least one scrambling sequence, where the information of the FEC includes at least one of the following information: a type of the FEC, a rate of the FEC or a number of coded bits by the FEC.

With reference to the first aspect or any one of the embodiments, in another embodiment, generating the feedback signal based on the sensing feedback configuration and the sensing parameters includes: generating, by the first sensing node, an unmodulated waveform based on a first function, where the first function is defined based on a symbol-level scrambling with the at least one identity; obtaining, by the first sensing node, the sensing feedback content based on the sensing parameters; modulating, by the first sensing node, the unmodulated waveform based on the sensing feedback content to obtain a sensing feedback codeword; and generating, by the first sensing node, the feedback signal based on the sensing feedback codeword.

In this implementation, the scrambling is implemented based on a symbol-level scrambling with at least one scrambling sequence of the at least one ID, which applies to cases where the sensing feedback content is digital or analog in an analog domain sensing feedback codebook scenario.

With reference to the first aspect or any one of the embodiments, in another embodiment, the sensing feedback content is in discrete format, and generating the feedback signal based on the sensing feedback configuration and the sensing parameters includes: obtaining, by the first sensing node, the sensing feedback content based on the sensing parameters; selecting, by the first sensing node, a first function among a plurality of functions for conveying N bits information based on the sensing feedback content to obtain the sensing feedback codeword, where the first function is defined based on a symbol-level scrambling with the at least one identity, N is a length of the sensing feedback codeword; and generating, by the first sensing node, the feedback signal based on the first function.

In this implementation, the scrambling is implemented based on a symbol-level scrambling with at least one scrambling sequence of the at least one ID, which applies to cases where the sensing feedback content is discrete in an analog domain sensing feedback codebook scenario.

With reference to the first aspect or any one of the embodiments, in another embodiment, the first function is a based on at least one scrambling function, the at least one scrambling function is in one-to-one correspondence with the at least one identity, and each scrambling function is used to convert a corresponding identity into a time domain function.

With reference to the first aspect or any one of the embodiments, in another embodiment, the scrambling function is defined as

$${λ}_{{X}_{I D}} ( t ) = {\sum }_{n = 0}^{N - 1} {c}_{n} \prod ( \frac{N t}{T} - n ) ,$$

where λ_{X}_{_{ID}} (t) denotes the scrambling function, Π(t) denotes a pulse function defined as

$$\prod ( t ) = \{ \begin{matrix}1 , & 0 \leq t < 1 \\ 0 , & otherwise\end{matrix} , {\{ {c}_{n} \}}_{n = 0}^{N - 1}$$

denotes a complex sequence based on X_{ID}, X_{ID} is one of the at least one identity, N is a length of the sensing feedback codeword and T denotes the whole transmission time of the feedback signal.

With reference to the first aspect or any one of the embodiments, in another embodiment, the complex sequence is a Zadoff-Chu sequence or a Pseudo-Noise sequence, and the Zadoff-Chu sequence or the Pseudo-Noise sequence is generated by setting X_{ID} as a seed value.

With reference to the first aspect or any one of the embodiments, in another embodiment, the sensing feedback content is in analog format, and the method further includes: processing, by the first sensing node, the sensing feedback content with at least one second function, where the sensing feedback codeword is a product of the first function and the processed sensing feedback content.

With reference to the first aspect or any one of the embodiments, in another embodiment, in a hopping scenario, the first function includes a plurality of time domain functions, and each time domain function is based on a symbol-level scrambling with the at least one identity.

In this implementation, the first function is defined by a plurality of time domain functions, which supports a hopping scenario.

With reference to the first aspect or any one of the embodiments, in another embodiment, the sensing feedback configuration includes at least one of the following information: a hopping parameter, at least one scrambling function, or at least one second function, where the at least one scrambling function is in one-to-one correspondence with the at least one identity, each scrambling function is used to convert a corresponding identity into a time domain function, and the at least one second function is used to process the sensing feedback content.

According to a second aspect, an embodiment of the present application provides a method for sensing, and the method could be performed by a second sensing node. Unless otherwise specified, the second sensing node may refer to the second sensing node itself or an apparatus that supports the function of the second sensing node. The technical effect of the second aspect or any one of its embodiments can refer to that of the first aspect, and it will not be repeated herein.

The method includes: transmitting, by the second sensing node, a sensing signal to a first sensing node to sense a sensing target; receiving, by the second sensing node, a feedback signal, where the feedback signal carries a sensing feedback content which indicates sensing parameters, the sensing parameters indicate properties of the sensing target; and determining, by the second sensing node, the sensing feedback content by de-scrambling the feedback signal based on at least one identity.

With reference to the second aspect, in an embodiment, the at least one identity comprises at least one of the following: an identity of the first sensing node, an identity of the second sensing node and an identity of a sensing session for estimating the sensing parameters.

With reference to the second aspect or any one of the embodiments, in another embodiment, the method further includes: transmitting, by the second sensing node, a sensing feedback configuration to the first sensing node, where the sensing feedback configuration is used to generate the feedback signal and includes a first mapping between a sensing feedback codeword and the at least one identity, the sensing feedback codeword is used to carry the sensing feedback content, and the feedback signal is based on the sensing feedback codeword.

With reference to the second aspect or any one of the embodiments, in another embodiment, the first mapping includes a mapping between scrambling parameters and the at least one identity, where the scrambling parameters are used to scramble the sensing feedback content to obtain the sensing feedback codeword.

With reference to the second aspect or any one of the embodiments, in another embodiment, the sensing feedback configuration further includes at least one of the following information: a format of the sensing feedback content, a resource for transmitting the feedback signal, or a sensing feedback codebook including the sensing feedback codeword.

With reference to the second aspect or any one of the embodiments, in another embodiment, the format of the sensing feedback content is in binary format, in discrete format or in analog format, and/or the sensing feedback codebook is defined in digital domain or in analog domain.

With reference to the second aspect or any one of the embodiments, in another embodiment, determining sensing feedback content by de-scrambling the feedback signal based on at least one identity includes: converting, by the second sensing node, the at least one identity into at least one scrambling sequence, where the at least one scrambling sequence is in one-to-one correspondence with the at least one identity; de-scrambling, by the second sensing node, the feedback signal based on the at least one scrambling sequence to obtain the sensing feedback codeword; and obtaining, by the second sensing node, the sensing feedback content based on the sensing feedback codeword.

With reference to the second aspect or any one of the embodiments, in another embodiment, the sensing feedback configuration further includes at least one of the following information: a quantization function used to convert the sensing parameters in analog format to the sensing feedback content in digital format, a length of the sensing feedback content, information of a forward error correction (FEC) used to encode the sensing feedback content, or one or more binary functions used to obtain the at least one scrambling sequence, where the information of the FEC includes at least one of the following information: a type of the FEC, a rate of the FEC or a number of coded bits by the FEC.

With reference to the second aspect or any one of the embodiments, in another embodiment, determining sensing feedback content by de-scrambling the feedback signal based on at least one identity includes: generating, by the second sensing node, an unmodulated waveform based on a first function, where the first function is defined based on symbol-level scrambling with the at least one identity; de-modulating, by the second sensing node, the feedback signal based on the unmodulated waveform to obtain the sensing feedback codeword; and obtaining, by the second sensing node, the sensing feedback content based on the sensing feedback codeword.

With reference to the second aspect or any one of the embodiments, in another embodiment, the first function is a based on at least one scrambling function, the at least one scrambling function is in one-to-one correspondence with the at least one identity, and each scrambling function is used to convert a corresponding identity into a time domain function.

With reference to the second aspect or any one of the embodiments, in another embodiment, the scrambling function is defined as

$${λ}_{{X}_{I D}} ( t ) = {\sum }_{n = 0}^{N - 1} {c}_{n} \prod ( \frac{N t}{T} - n ) ,$$

where λ_{X}_{_{ID}} (t) denotes the scrambling function, Π(t) denotes a pulse function defined as

$$\prod ( t ) = \{ \begin{matrix}1 , & 0 \leq t < 1 \\ 0 , & otherwise\end{matrix} , {\{ {c}_{n} \}}_{n = 0}^{N - 1}$$

denotes a complex sequence based on X_{ID}, X_{ID} is one of the at least one identity, N is a length of the sensing feedback codeword and T denotes the whole transmission time of the feedback signal.

With reference to the second aspect or any one of the embodiments, in another embodiment, the complex sequence is a Zadoff-Chu sequence or a Pseudo-Noise sequence, and the Zadoff-Chu sequence or the Pseudo-Noise sequence is generated by setting X_{ID} as a seed value.

With reference to the second aspect or any one of the embodiments, in another embodiment, in a hopping scenario, the first function includes a plurality of time domain functions, and each time domain function is based on symbol-level scrambling with the at least one identity.

With reference to the second aspect or any one of the embodiments, in another embodiment, the sensing feedback configuration further includes at least one of the following information: a hopping parameter, at least one scrambling function, or at least one second function, where the at least one scrambling function is in one-to-one correspondence with the at least one identity, each scrambling function is used to convert a corresponding identity into a time domain function, the at least one second function is used to process the sensing feedback content.

According to a third aspect, an embodiment of the present application provides an apparatus that is configured to implement the methods provided by the above-mentioned aspects or their embodiments. Specifically, the apparatus may include units and/or modules, such as a processing unit and/or a communication unit, for the execution of any of the methods provided by the above-mentioned aspects or their embodiments.

In an embodiment of the third aspect, the apparatus is the first sensing node or the second sensing node. When the apparatus is the first sensing node or the second sensing node, the communication unit may be a transceiver, or an input/output interface, or a communication interface. The processing unit may be at least one processor. Optionally, the transceiver is a transmitting and receiving circuit. Optionally, the input/output interface is an input/output circuit.

In another embodiment of the third aspect, the apparatus is a communication device, an integrated circuit, a system-on-chip, a system-in-package, or a multi-chip module in the first sensing node or the second sensing node. When the apparatus is a communication device, an integrated circuit, a system-on-chip, a system-in-package, or a multi-chip module in the first sensing node or the second sensing node, the communication unit may be an input/output interface, an interface circuit, an output circuit, or an input circuit. The processing unit may be at least one processor, processing circuit or logic circuit, etc.

According to a fourth aspect, an embodiment of the present application provides an apparatus, and the apparatus includes one or more processors, where the one or more processors are configured to execute a computer program or instructions stored in a memory to implement any of the methods provided by the above-mentioned aspects or their embodiments.

In an embodiment of the fourth aspect, the apparatus further includes the memory.

In an embodiment of the fourth aspect or any one of the embodiments of the fourth aspect, the apparatus is the first sensing node or the second sensing node.

In another embodiment of the fourth aspect or any one of the embodiments of the fourth aspect, the apparatus is a communication device, an integrated circuit, a system-on-chip, a system-in-package, or a multi-chip module in the first sensing node or the second sensing node.

According to a fifth aspect, an embodiment of the present application provides an apparatus, and the apparatus includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the fifth aspect, the apparatus further includes the memory.

According to a sixth aspect, an embodiment of the present application provides a processor which is configured to execute a computer program or instructions stored in a memory to implement any of the methods provided by the above-mentioned aspects or their embodiments.

According to a seventh aspect, an embodiment of the present application provides a computer-readable medium on which a program or instructions are recorded, where the program or the instructions, when executed, enables a computer to implement any of the methods provided by the above-mentioned aspects or their embodiments.

According to an eighth aspect, an embodiment of the present application provides a computer program product, where the computer program product includes instructions to implement any of the methods provided by the above-mentioned aspects or their embodiments.

According to a ninth aspect, an embodiment of the present application provides a computer program, where the computer program, when executed, enables a computer to implement any of the methods provided by the above-mentioned aspects or their embodiments.

According to a tenth aspect, an embodiment of the present application provides an apparatus, which includes at least one processor and a communication interface, where the at least one processor is used to obtain a computer program or instructions stored in a memory through the communication interface to implement any of the methods provided by the above-mentioned aspects or their embodiments. The communication interface can be implemented by hardware or software.

In an embodiment of the tenth aspect, the apparatus further includes the memory.

When the method provided in this application is executed by an integrated circuit, such as a chip, a system-on-chip, a system-in-package, or a multi-chip module, this application does not limit the number of integrated circuits for implementing the method. For example, the method may be executed by one integrated circuit, or the method may be executed by two or more integrated circuits. In addition, when the number of integrated circuits is two or more, the integrated circuits may be produced by a same manufacturer or different manufacturers, or a combination of same and different manufacturers, without limitation.

According to an eleventh aspect, an embodiment of the present application provides a communication system, where the communication system includes a communication apparatus used to perform the method according to the first aspect or its embodiments; and/or, a communication apparatus used to perform the method according to the second aspect or its embodiments.

### DESCRIPTION OF DRAWINGS

One or more embodiments are exemplarily described by corresponding accompanying drawings, and these exemplary illustrations and accompanying drawings constitute no limitation on the embodiments. Elements with the same reference numerals in the accompanying drawings are illustrated as similar elements, and the drawings are not limited to scale, in which:

FIG. 1 is an example of different sensing sessions being performed by a same sensing TX node.

FIG. 2 is an example of feedback signals with two sensing RXs and two sensing sessions.

FIG. 3 is a schematic diagram of a communication system to which the embodiments of this application are applicable.

FIG. 4 is a schematic diagram of a communication method 400.

FIG. 5 is an example of Chirp-based sensing feedback signal design.

FIG. 6 is a schematic diagram of an apparatus provided by the embodiments of this application.

FIG. 7 is a schematic diagram of another apparatus provided by the embodiments of this application.

FIG. 8 is a schematic diagram of an apparatus provided by the embodiments of this application.

### DESCRIPTION OF EMBODIMENTS

In order to understand features and technical contents of embodiments of the present application in detail, implementations of the embodiments of the present application will be described in detail below with reference to the accompanying drawings, and the attached drawings are only for reference and illustration purposes, and are not intended to limit the embodiments of the present applications. In the following technical descriptions, for ease of explanation, numerous details are set forth to provide a thorough understanding of the disclosed embodiments.

Related technologies and concepts are introduced here firstly in order to have better understanding of technical solution proposed by the present application.

In ISAC networks, various types of nodes may perform various sensing tasks. “sensing tasks” is also referred to as “sensing sessions”. These tasks include but are not limited to: sensing target detection, sensing target categorization, distance/range detection, angle detection, and/or doppler detection. A sensing feedback content of the sensing target detection may be binary. A sensing feedback content of the sensing target categorization may be discrete. A sensing feedback content of the distance/range detection, the angle detection or the doppler detection may be analog.

In ISAC networks, a sensing TX node (also referred to as “sensing TX”) and/or a sensing RX node (also referred to as “sensing RX”) can be a transmission reception point (TRP), a user equipment (UE) or a dedicated sensing node (SeN). A sensing can be scheduled by a sensing coordinator (can be a network node, e.g. sensing management function (SMF)). Or the sensing can be done in an uncoordinated manner, for example, two UEs can act as the sensing TX node and the sensing RX node respectively. In addition, one sensing TX node can initiate multiple sensing sessions. Different sensing sessions may request different sensing parameter measurements and/or may focus on different areas/regions. For example, the sensing may be performed over different spatial directions/beams, each of which defines a separate sensing session.

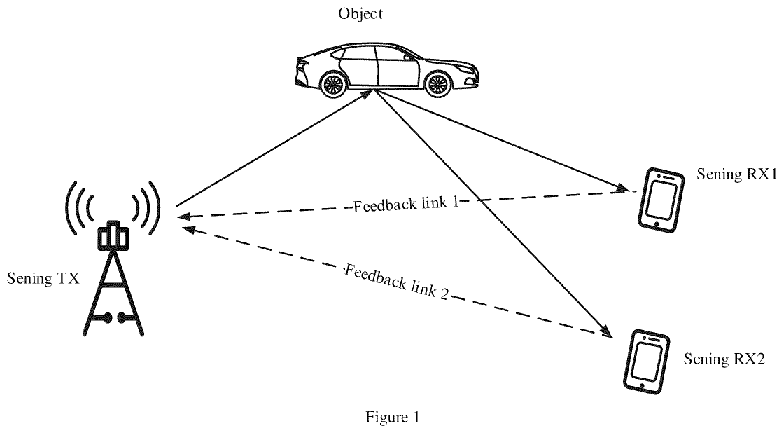

An example of different sensing sessions being performed by a same sensing TX node is shown in FIG. 1. As can be seen in FIG. 1, a sensing TX may define two sensing sessions. One of the two sensing session is to be performed by a sensing RX1 and the other sensing session is to be performed by a sensing RX2. For example, the sensing RX1 may be requested to detect the existence of a sensing target (a car in FIG. 1) and report a result (e.g. a binary indicator of yes or no) to the sensing TX or another responsible node in the network. In an example of the sensing RX1 reporting the result to the sensing TX, a feedback link for the sensing RX1 is shown as a dashed line in FIG. 1. The sensing RX2 may be requested to estimate and report more additional information of the sensing target including a distance, velocity, heading, etc. to the sensing TX or another responsible node in the network. In an example of the sensing RX2 reporting the additional information to the sensing TX, a feedback link for the sensing RX2 is shown as a dashed line in FIG. 1.

In order to differentiate different sensing signals transmitted by different sensing TX nodes and/or for different sensing sessions, a general idea may be to associate the sensing signal with these two IDs, i.e. an identity (ID) of the sensing TX node and an ID of the sensing session. For example, the sensing signal may be defined as follows: s(t)=f(t, SeN_{ID}, SeS_{ID}), where SeN_{ID} denotes a sensing node ID (here is the sensing TX node ID), SeS_{ID} denotes a sensing session ID, and f(.) is a mapping/association function. An association of the sensing signal to the sensing TX node ID and/or the sensing session ID helps the sensing RX to distinguish different sensing signals that might be transmitted by different sensing TXs and/or for different sensing sessions.

The same rationale can be followed for reporting the sensing results by the sensing RX(s). However, this may imply additional challenges. In addition to the sensing TX node ID and the sensing session ID corresponding to the sensing TX, the sensing RX may be required to include its own sensing ID in the feedback signal conveying the sensing results/the sensing feedback report. It can be appreciated that embedding all these IDs in the feedback signal can incur lots of sensing overhead which may need to be addressed. “feedback signal” is also referred to as “sensing feedback signal,” “sensing feedback report signal,” “sensing feedback report” or “feedback report,” etc.

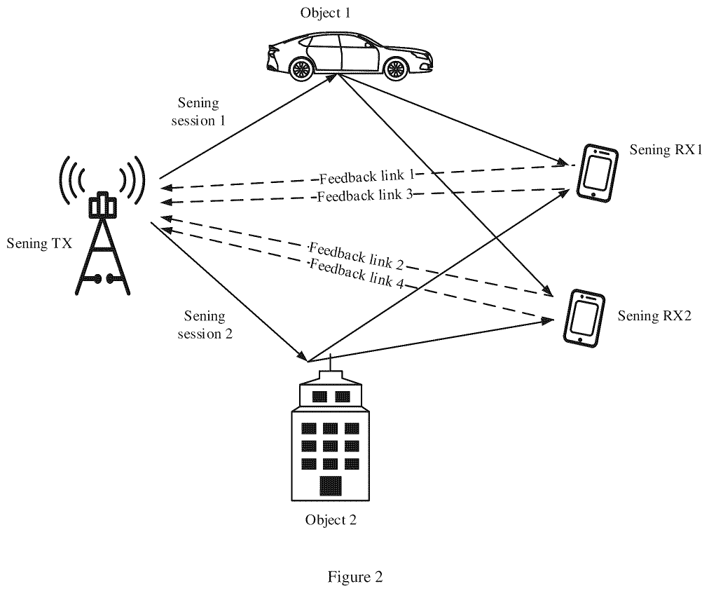

An example of feedback signals with two sensing RXs and two sensing sessions is shown in FIG. 2. As shown in FIG. 2, there is one sensing TX defining two sensing sessions (corresponding to two sensing targets shown in FIG. 2), and there are two sensing RXs (shown as Sensing RX1 and Sensing RX2). It can be appreciated that there are four different feedback links shown as dashed lines in this example. The example in FIG. 2 may show that the number of distinct feedback signals in the ISAC networks can overwhelmingly be large. It can be understood that the number of distinct feedback signals can be as large as N_{sTX}×N_{sRX}×N_{Ses}, in a network with N_{sTX} potential sensing TX nodes, N_{sRX} potential sensing RX nodes and N_{sRX} sensing sessions per sensing TX node.

In some solutions, the feedback signals can be configured in an uncoordinated manner to save signaling overhead. In this case, the feedback signals can be transmitted potentially by any node and at any time in a given region. This is somehow similar to grant-free/configured grant transmission type in the context of communication. In the uncoordinated manner, it might not be possible to provide time/frequency resources in a way that guarantees collision avoidance of the feedback signals.

Therefore, there might be some technical problems to be addressed regarding the large amount of feedback signals. A first problem is how to deal with potential interference between the sensing feedback signals. The first problem can be resolved by orthogonalization of time/frequency resources allocated for different feedback signals, which might not be efficient because it implies lots of resource overhead. A second problem is how to embed sensing related IDs in the feedback signal. One solution for the second problem would be to put the sensing related IDs in a MAC header, which may not be efficient since the overhead of the sensing related IDs can be higher than the sensing feedback content itself. For example, a binary/discrete sensing feedback content may be only a few bits of information.

To solve the problems above, embodiments of the present application provide a method and an apparatus for sensing, which can reduce the overhead for transmitting feedback signals.

Before introducing the embodiments of the present application, communication systems to which the embodiments are applicable are described below.

The embodiments of the present application can be applied to various communication systems, such as: 5th generation (5G) or new radio (NR) systems, long term evolution (LTE) systems, LTE frequency division duplex (FDD) systems, LTE time division duplex (TDD) systems, universal mobile telecommunication system (UMTS), worldwide interoperability for microwave access (WiMAX) systems, public land mobile network (PLMN), wireless local area network (WLAN) systems, satellite communication systems, sixth generation (6G) mobile communication systems, future communication systems, or a combination of multiple systems above. The embodiments of the present application can also be applied to device to device (D2D) communication systems, vehicle-to-everything (V2X) communication systems, machine to machine (M2M) communication systems, machine type communication (MTC) systems, and internet of things (IoT) communication systems, uncrewed aerial vehicle (UAV) communication systems or other communication systems.

One device in a communication system can transmit signals to another device or receive signals from another device. The signals can include information, signaling or data. The device can also be referred to as an entity, a network entity, a communication device, a communication module, a node, a communication node, etc.

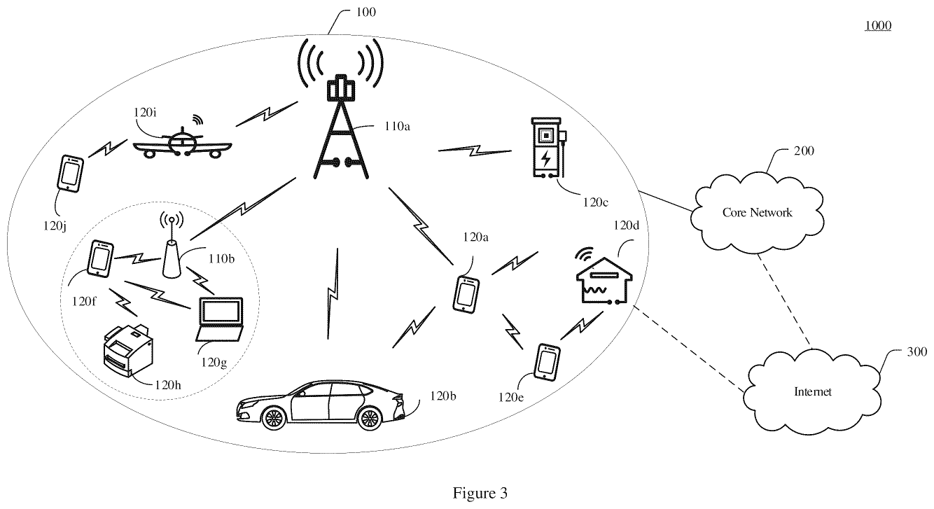

For ease of understanding the embodiments of the present application, a communication system shown in FIG. 3 is used as an example to describe in detail a communication system to which the embodiments of this application are applicable.

Referring to FIG. 3, the communication system 1000 includes a radio access network (RAN) 100 and a core network 200. In one possible implementation, the communication system 1000 can further include an Internet 300. The RAN 100 may include at least one RAN device (110a and 110b in FIG. 3) and at least one terminal device (120a-120j in FIG. 3). The terminal device is connected wirelessly to the RAN device, and the RAN device is connected wirelessly or wired to the core network. The core network device and the RAN device can be separate physical devices, or functions of the core network device and logical functions of the RAN device can be integrated on a same physical device, or part of functions of the core network device and part of logical functions of the RAN device can be integrated on a same physical device. Terminal devices can be connected to each other wirelessly or wired. RAN devices can be connected to each other wirelessly or wired. It can be appreciated that FIG. 3 is only a schematic diagram, and the communication system can also include other network devices, such as relay devices or dedicated sensing nodes, which are not shown in FIG. 3.

The terminal devices in the communication system 1000 can also be referred to as terminals, user equipment (UE), mobile stations, mobile terminals, etc. The terminal devices can be widely used in various scenarios, such as D2D, V2X, MTC, IoT, virtual reality, augmented reality, industrial control, autonomous driving, telemedicine, smart grid, smart furniture, smart office, smart wear, smart transportation, smart city, etc. The terminal devices can be mobile phones, tablets, computers with wireless transceivers, wearable devices, vehicles, drones, helicopters, aircraft, ships, robots, robotic arms, smart home devices, etc.

The RAN 100 can be a cellular system associated with the 3rd generation partnership project (3GPP), such as a 4G mobile communications system, a 5G mobile communications system, or a future-oriented evolution system. The RAN 100 can also be an open RAN (O-RAN or ORAN), or a cloud RAN (CRAN). The RAN 100 can also be a communication system that integrates two or more of the above systems.

The RAN devices, sometimes referred to as RAN nodes, RAN entities, or access nodes, are a part of a communications system that helps terminal devices achieve radio access. Multiple RAN devices in the communication system 1000 can be nodes of the same type or nodes of different types.

In one possible scenario, a RAN device can be a base station, an evolved NodeB (eNodeB), an access point (AP), a TRP, a next generation NodeB (gNB), a next generation base station in 6G mobile communication system, or base station in future mobile communication system, etc. The RAN node can be a macro base station (110a in FIG. 3), a microbase or indoor station (nob in FIG. 3), a relay or donor node, or a radio controller in a CRAN scenario. For example, the RAN node can also be a server, a wearable device, a vehicle or a vehicle-mounted device, etc. For example, the RAN node in V2X scenario can be a road side unit (RSU).

In another possible scenario, multiple RAN devices cooperate to assist terminal devices to achieve radio access, and different RAN devices implement some of functions of a base station. For example, the RAN device can be a centralized unit (CU), a distributed unit (DU), a CU-control plane (CP) (CU-CP), a CU-user plane (UP) (CU-UP), or a radio unit (RU), etc. The CU and the DU can be configured separately or included in a same network element (NE) (e.g. a baseband unit (BBU)). The RU can be included in a radio frequency device or a radio frequency unit, such as a remote radio unit (RRU), a radio frequency unit (RFU), an active antenna unit (AAU), a radio frequency unit (RFU) or a remote radio head (RRH).

The CU, the DU, or the RU may have different names in different systems. For example, in an ORAN system, the CU can also be called open CU (open-CU or O-CU), the DU can also be called open DU (open-DU or O-DU), and the RU can also be called open RU (open-RU or O-RU). Any one of the CU, the DU and the RU can be implemented through software modules, hardware modules, or a combination of software modules and hardware modules.

RAN devices and terminal devices can be fixed or movable. RAN devices and terminal devices can be deployed on land, including indoors or outdoors, handheld or vehicle-mounted. RAN devices and terminal devices can also be deployed on water. RAN devices and terminal devices can also be deployed on an aircraft, a balloon or a satellite.

Roles of a RAN device and a terminal device can be relative. For example, the helicopter or drone 120i in FIG. 3 can be configured as a mobile base station, and the terminal device 120i is the RAN device for the terminal device 120j that accesses the RAN 100 through 120i. However, for the RAN device 110a, 120i is the terminal device, that is, the communication between 110a and 120i is through an air interface protocol.

Unless otherwise specified, the RAN device or the terminal device may refer to the RAN device or the terminal device itself or an apparatus that supports the function of the RAN device or the terminal device. The apparatus can be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus can be installed in the RAN device or in the terminal device. The apparatus may comprise one or more integrated circuits or comprise one or more integrated circuits and other discrete components.

It should be understood that the communication system shown above is only an illustrative illustration. The communication systems to which the embodiments of this application apply are not limited herein. Any communication system that is capable of realizing the functions of the above NEs is applicable to the embodiments of this application.

The embodiments of this application are described below.

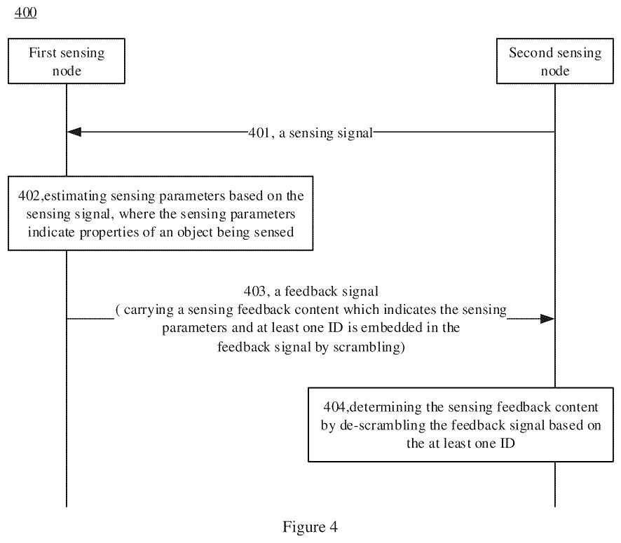

FIG. 4 is a schematic diagram of a communication method 400 provided by the embodiments of this application. The method 400 can be performed by a first sensing node and a second sensing node. Unless otherwise specified, the first sensing node or the second sensing node may refer to the first sensing node or the second sensing node itself or an apparatus that supports the function of the first sensing node or the second sensing node. The first network device and/or the second network device may be a RAN device or a terminal device in FIG. 3. The first network device and/or the second network device may also be a dedicated sensing node which is not shown in FIG. 3.

The method 400 specifically includes the following steps.

At Step 401, the second sensing node transmits a sensing signal to the first sensing node to sense a sensing target, and accordingly the first sensing node receives the sensing signal.

The first sensing node may also be referred to as a RX sensing node. The second sensing node may also be referred to as a TX sensing node.

The sensing target can be any tangible target that can reflect electromagnetic waves in the environment. The sensing target can be active which is capable of connecting to the network, such as a terminal device. The sensing target can be passive which is not capable of connecting to the network and transmission/reception of radio frequency (RF) signals, such as a mountain, a forest, a building, a pedestrian or other fixed/movable target. The sensing target may also be referred to as an object, a sensed object, a detected object, a sensed target, a target, a detected target or a sensed device, etc.

The sensing signal can be reflected at the sensing target and then reach the first sensing node. The sensing signal is used to sense (or detect) the sensing target. The sensing signal is also referred to as a detection signal, a radar signal, a radar sensing signal, a radar detection signal, or an environmental sensing signal. The sensing signal may be a pulse signal or a signal in a wireless communication system or in a radar system. For example, the sensing signal may be an orthogonal frequency division multiplexing (OFDM) signal that is modulated on a subcarrier with a specific sequence. The sensing signal can also be a linearly frequency modulated signal (LFM), also referred to as a chirp signal. One example of the LFM signal is a frequency modulated continuous wave (FMCW) signal. The specific sequence may be associated with an ID of the second sensing node (hereinafter referred to as SeN_{ID} of the TX node or TXSeN_{ID}) and/or an ID of a sensing session (hereinafter referred to as SeS_{ID}). The sensing session is for estimating sensing parameters of the sensing target. The specific sequence may be any one of the following sequences: Zadoff-Chu (ZC) sequence, Pseudo-Noise sequence, or other predefined sequence.

In a possible implementation, the second sensing node transmits a sensing signal based on a sensing signal configuration. The sensing signal configuration is used to transmit the sensing signal. For example, the sensing signal configuration includes a mapping between parameters of the sensing signal and at least one of TXSeN_{ID} and SeS_{ID}.

The sensing signal configuration may be determined by the second sensing node. Or the sensing signal configuration may be sent to the second sensing node by another node responsible for coordinating the sensing activities. For example, the node responsible for coordinating the sensing activities may be a sensing coordinator which can be a network node (e.g. SMF).

At Step 402, the first sensing node estimates sensing parameters based on the sensing signal.

The sensing parameters can indicate properties of the sensing target.

In a possible implementation, the first sensing node estimates sensing parameters based on the sensing signal and the sensing signal configuration. The sensing signal configuration may be sent to the first sensing node by the second sensing node or another node responsible for coordinating the sensing activities. The sensing signal configuration includes a mapping between parameters of the sensing signal and at least one of TXSeN_{ID} and SeS_{ID}.

At Step 403, the first sensing node transmits a feedback signal.

The first sensing node may transmit the feedback signal to the second sensing node or another node responsible for coordinating the sensing activities. FIG. 4 shows an example of transmitting the feedback signal to the second sensing node. The feedback signal carries a sensing feedback content which indicates the sensing parameters estimated in Step 402.

In order to differentiate different feedback signals transmitted by different sensing RX nodes and/or for different sensing sessions, the feedback signal may be associated with at least one ID. For example, the at least one ID is sensing-related and includes at least one of an ID of the first sensing node (hereinafter referred to as SeN_{ID} of the RX node or RXSeN_{ID}), TXSeN_{ID} or SeS_{ID}. The embodiments of this application do not limit the way in which the association of the feedback signal to at least one sensing-related ID is implemented. In a possible implementation, the at least one sensing-related ID is embedded in the feedback signal by scrambling. For example, RXSeN_{ID} can be configured for a plurality of nodes assigned for receiving the sensing signal by the second sensing node or another node responsible for coordinating the sensing activities.

Before Step 403, the first sensing node may generate the feedback signal. In a possible implementation, the feedback signal may be constructed in accordance with a sensing feedback configuration transmitted by the second sensing node or another node responsible for coordinating the sensing activities. In other words, the first sensing node may generate the feedback signal based on the sensing feedback configuration. The sensing feedback configuration is used to indicate a first mapping between a sensing feedback codeword and the at least one sensing-related ID. The sensing feedback codeword is used to carry the sensing feedback content, and the feedback signal is based on the sensing feedback codeword. In some embodiments, the first mapping includes a mapping between scrambling parameters and the at least one sensing-related ID, where the scrambling parameters are used to scramble the sensing feedback content to obtain the sensing feedback codeword. The sensing feedback configuration is further used to indicate at least one of the following information: a format of the sensing feedback content, a resource for transmitting the feedback signal, or a sensing feedback codebook including the sensing feedback codeword.

In some embodiments, the sensing feedback configuration may be signaled to the first sensing node in the form of higher layer signaling.

An example of the sensing feedback configuration is provided as follows. The sensing feedback configuration may include a definition of a sensing feedback content format, a definition of feedback time/frequency resources, a definition of a sensing feedback codebook and a definition of the first mapping between the sensing feedback codeword and at least one of RXSeN_{ID}, TXSeN_{ID} and SeS_{ID}.

The definition of the sensing feedback content format may include what information and in what format should be fed back. An example of the definition of the sensing feedback content format can be whether the sensing feedback content is in binary format, in discrete format or in analog format. Examples of a binary feedback include detection or no detection for a specific sensing target. Examples of a discrete feedback include a number of sensing targets and/or a categorization index of the sensing targets (e.g. human, car, bus, truck, moving, non-moving, etc.), or a virtual transmit point (vTP) index report, etc. Examples of an analog feedback include a delay report, an angle report, or a Doppler report, etc.

In some embodiments, the definition of the feedback time/frequency resources might be provided based on a mapping between the at least one of TXSeN_{ID} or SeS_{ID} to the feedback time/frequency resources, instead of explicitly signaling of the feedback time/frequency resources.

In some embodiments, the definition of the sensing feedback codebook includes whether the sensing feedback codebook is defined in the bit domain, in the discrete complex domain or in the analog domain. In some embodiments, the sensing feedback codebook can implicitly be obtained from the sensing feedback content format. The sensing feedback codebook includes a set of codewords.

In some embodiments, the definition of the first mapping includes a definition of scrambling sequences in bit domain, in symbol domain, or in analog domain where scrambling parameters of the scrambling sequence are mapped to at least one of TXSeN_{ID}, RXSeN_{ID} or SeS_{ID}.

In some embodiments, the definition of the first mapping may include how to select a codeword from a plurality of codewords (i.e. a codebook) according to the sensing feedback content and other parameters of the sensing feedback configuration.

In some embodiments, RXSeN_{ID} might not be required hence the first mapping may not include RXSeN_{ID}. As an example, in a case of one sensing RX node, the first mapping may not include RXSeN_{ID}.

In some embodiments, a mapping between TXSeN_{ID} and the feedback time/frequency resources is provided to the first sensing node. In such a case, the first mapping may not include TXSeN_{ID}.

In some embodiments, a mapping between SeS_{ID} and the feedback time/frequency resources is provided to the first sensing node. In such a case, the first mapping may not include SeS_{ID}.

In some embodiments, a mapping between TXSeN_{ID}, SeS_{ID} and the feedback time/frequency resources is provided to the first sensing node. In such a case, the first mapping may include neither TXSeN_{ID} nor SeS_{ID}.

The embodiments of this application do not limit the way in which the scrambling mentioned above is implemented. The scrambling in different scenarios is explained below.

### Scenario 1: Digital Domain Sensing Feedback Codebook

In this scenario, the first sensing node may convert the at least one sensing-related ID into at least one scrambling sequence which is in one-to-one correspondence with the at least one sensing-related identity, obtain the sensing feedback content based on the sensing parameters, scramble the sensing feedback content with the at least one scrambling sequence to obtain the sensing feedback codeword, and generate the feedback signal based on the sensing feedback codeword. In other words, the scrambling is implemented based on a bit-level scrambling with at least one scrambling sequence of the at least one sensing-related ID. “bit-level scrambling” is also referred to as “bit-domain scrambling”.

This way of scrambling may be applicable to cases that the sensing feedback content itself is in binary format or in discrete format, or the cases that the first sensing node is configured to convert an analog sensing feedback content (e.g. range, angle, Doppler, velocity) to a digital sensing feedback content or a digital value (e.g. through quantization). In this case, the sensing feedback content can be represented by a binary vector of bits. The sensing feedback content can be directly obtained from the sensing parameters if the sensing parameters are binary/discrete, or the sensing feedback content can be obtained by quantizing the sensing parameter based on some quantization functions if the sensing parameters are analog.

In an example of embedding TXSeN_{ID}, RXSeN_{ID} and SeS_{ID} to the feedback signal, a formula expression of the above way of scrambling is provided below.

In the case of digital-domain sensing feedback codebook, the sensing feedback codeword, denoted by s_{fb}, can be represented as a vector of bits with size N, and can be written as s_{fb}=g(SeN_{fb}, TXSeN_{ID}, SeS_{ID}, RXSeN_{ID}), where SeN_{fb} denotes the sensing feedback content, TXSeN_{ID} denotes the ID of the TX sensing node, SeS_{ID} denotes the ID of the sensing session, RXSeN_{ID} denotes the ID of the RX sensing node, N≥M, and M denotes a length of the sensing feedback content.

In some embodiments, the function g(.) can be a combination of a FEC and a bit-level scrambling. The FEC is used to convert the raw binary information bits SeN_{fb} to the coded bits SeN_{fb,coded}. Examples of the FEC may include a polar code, a LDPC code, a convolutional code, a turbo code, or a repetition code. If g(.) does not include the FEC, SeN_{fb,coded}=SeN_{fb} and M=N. The bit-level scrambling is used to scramble the coded bits SeN_{fb,coded} with TXSeN_{ID}, RXSeN_{ID}, and SeS_{ID}. In this embodiment, the sensing feedback codeword s_{fb} can be defined ass_{fb}=g(SeN_{fb}, TXSeN_{ID}, SeS_{ID}, RXSeN_{ID})=FEC(SeN_{fb})⊕σ₁(TXSeN_{ID})⊕σ₂ (SeS_{ID})⊕σ₃ (RXSeN_{ID}),where ⊕ denotes the binary addition resembling the scrambling operation, and σᵢ is a binary function used to map the corresponding ID to a scrambling sequence with a size N, i=1, 2 and 3.

Compared with separately putting the sensing-related IDs, the bit-level scrambling enables efficient separation of sensing feedback signals in bit domain without increasing the sensing feedback payload size.

In the case of digital-domain sensing feedback codebook, the sensing feedback configuration may include at least one of the following information: a quantization function used to convert the sensing parameters in analog format to the sensing feedback content in digital format, a length of the sensing feedback content (i.e. the value M), information of the FEC used to encode the sensing feedback content, or one or more binary functions (i.e. σᵢ) used to obtain the at least one scrambling sequence, where the information of the FEC includes at least one of the following information: a type of the FEC, a rate of the FEC or a number of coded bits by the FEC. In a case of analog sensing parameters, the sensing feedback configuration may include information of the quantization function. If g(.) does not include the FEC, the sensing feedback configuration may not include the information of the FEC. If the feedback signal is configured not to relate to any of TXSeN_{ID}, RXSeN_{ID} and SeS_{ID}, the one or more binary functions may not include the binary function corresponding to that particular ID.

In addition, if the feedback signal is configured not to relate to any of TXSeN_{ID}, RXSeN_{ID} and SeS_{ID}, the bit-level scrambling function corresponding to that particular ID would not exist in the function g(.). For example, if RXSeN_{ID} is not to be embedded in the feedback signal, the sensing feedback codeword s_{fb} can be defined ass_{fb}=g(SeN_{fb}, TXSeN_{ID}, SeS_{ID})×FEC(SeN_{fb})⊕σ₁(TXSeN_{ID})⊕σ₂(SeS_{ID}).

It can be appreciated that in the case of digital-domain sensing feedback codebook, the feedback signal transmitted over-the-air is still an analog signal hence the transformation of the bit-domain sensing feedback codeword to the over-the-air signal may still need to be specified or configured.

In some embodiments, the feedback signal is transmitted through communication-specific channels (e.g. physical uplink control channel (PUCCH), physical uplink shared channel (PUSCH) or physical sidelink shared channel (PSSCH)). In these embodiments, the first sensing node may follow the same procedures as signals transmitted through the communication-specific channels for generation of the sensing feedback signal. The procedures may include at least one of the following: modulation, resource mapping, and waveform modulation, etc.

In some embodiments, the feedback signal is transmitted through sensing-specific channels (e.g. physical sensing channel). In these embodiments, all steps of the generation of the feedback signal may be specified/configured. The steps of the generation of the feedback signal may include at least one of the following: modulation, resource mapping, and waveform modulation, etc.

### Scenario 2: Analog Domain Sensing Feedback Codebook

For cases where the sensing feedback content is in digital format (e.g. if the sensing parameters are binary/discrete) or in analog format, in some embodiments, the first sensing node may generate an unmodulated waveform based on a first function which is defined based on a symbol-level scrambling with the at least one sensing-related ID, obtain the sensing feedback content based on the sensing parameters, modulate the unmodulated waveform based on the sensing feedback content to obtain the sensing feedback codeword, and generate the feedback signal based on the sensing feedback codeword. In other words, the scrambling is implemented based on a symbol-level scrambling for an unmodulated waveform with the at least one sensing-related ID.

For cases where the sensing feedback content is in discrete format, in some embodiments, the first sensing node may obtain the sensing feedback content based on the sensing parameters, select a first function among a plurality of functions for conveying N bits information based on the sensing feedback content to obtain the sensing feedback codeword, and generate the feedback signal based on the first function. Each of the plurality of functions is defined based on a symbol-level scrambling with the at least one sensing-related ID, and N is a length of the sensing feedback codeword. In other words, the scrambling is implemented based on a symbol-level scrambling for the first function from the plurality of functions with the at least one sensing-related ID.

“Symbol-level scrambling” is also referred to as “symbol-domain scrambling”.

In some embodiments, the first function above is based on at least one scrambling function. The at least one scrambling function is in one-to-one correspondence with the at least one sensing-related ID, and each scrambling function is used to convert a corresponding identity into a time domain function.

In some embodiments, the scrambling function is defined as

$${λ}_{{X}_{I D}} ( t ) = {\sum }_{n = 0}^{N - 1} {c}_{n} \prod ( \frac{N t}{T} - n ) ,$$

where λ_{X}_{_{ID}}(t) denotes the scrambling function, Π(t) denotes a pulse function defined as

$$\prod ( t ) = \{ \begin{matrix}1 , & 0 \leq t < 1 \\ 0 , & otherwise\end{matrix} , {\{ {c}_{n} \}}_{n = 0}^{N - 1}$$

denotes a complex sequence based on X_{ID}, X_{ID} is one of the at least one sensing-related ID, N is a length of the sensing feedback codeword and T denotes the whole transmission time of the feedback signal.

In some embodiments, the complex sequence is a Zadoff-Chu sequence or a Pseudo-Noise sequence, and the Zadoff-Chu sequence or the Pseudo-Noise sequence is generated by setting X_{ID} as a seed value.

In an example of embedding TXSeN_{ID}, RXSeN_{ID} and SeS_{ID} to the feedback signal, a formula expression of the above ways of scrambling is provided below.

In the case of digital-domain sensing feedback codebook, the sensing feedback codeword, denoted by s_{f}, can be represented as an analog function of time (t), and can be written as s_{fb}(t)=gₐ(t, SeN_{fb}, TXSeN_{ID}, SeS_{ID}, RXSeN_{ID}), where SeN_{fb} denotes the sensing feedback content, TXSeN_{ID} denotes the ID of the TX sensing node, SeS_{ID} denotes the ID of the sensing session, and RXSeN_{ID} denotes the ID of the RX sensing node.

The idea here is to define an unmodulated feedback waveform s_{fb,unmod}(t), which then will be modulated to embed the sensing feedback content SeN_{fb}.

The unmodulated feedback waveform s_{fb,unmod} (t) may be obtained based on TXSeN_{ID}, RXSeN_{ID} and SeS_{ID}, and can be written as s_{fb,unmod} (t)=g_{a,unmod}(TXSeN_{ID}, SeS_{ID}, RXSeN_{ID}).

In some embodiments, the function g_{a,unmod}(.) can be defined based on a symbol-level scrambling with some analog functions of TXSeN_{ID}, RXSeN_{ID} and SeS_{ID}.

As an example, g_{a,unmod}(.) can be defined based on a product of some scrambling functions, and can be written as g_{a,unmod}(.)=λ_{TXSeN}_{_{ID}}(t) λ_{SeS}_{_{ID}} (t) ARXSeN_{ID} (t), where λ_{X}_{_{ID}} (t) denotes an analog domain scrambling function which is used to map X_{ID} to a continuous time-domain function. X_{ID} can be either TXSeN_{ID}, RXSeN_{ID} and SeS_{ID}.

In some embodiments, in order to obtain λ_{X}_{_{ID}} (t), X_{ID} is firstly mapped to a complex sequence of a given length N. The complex sequence is denoted by ψ(X_{ID})=[c₀, . . . , c_{N-1}]. Then, the complex sequence (X_{ID}) is converted to an analog function through digital to analog conversion (DAC), which may be formulated as

$${λ}_{{X}_{I D}} ( t ) = {\sum }_{n = 0}^{N - 1} {c}_{n} \prod ( \frac{N t}{T} - n ) ,$$

where Π(t) may denote a pulse function defined as

$$Π ( t ) = \{ \begin{matrix}1 , & 0 \leq t < 1 \\ 0 , & otherwise\end{matrix} ,$$

N denotes a length of the sensing feedback codeword and T denotes a whole transmission time for the feedback signal.

In some embodiments, the complex sequence (X_{ID}) can be obtained based on generating a known sequence (e.g. Zadoff-Chu (ZC), Pseudo-Noise (PN)) by setting X_{ID} as the seed value through any known method in the art.

In cases where the sensing feedback content SeN_{fb} is analog, the sensing feedback codeword s_{fb}(t) may be formulated as s_{fb}(t)=η(SeN_{fb})s_{fb,unmod}(t), where η(.) denotes an analog function (analog input and analog output) used to process the sensing feedback content.

In cases where the sensing feedback content SeN_{fb} is discrete, the sensing feedback codeword s_{fb}(t) may be obtained either by modulating s_{fb,unmod} (t) or by selection of a particular s_{fb,unmod}(t) among a plurality of functions

$${s}_{fb , unmod} = {\{ {s}_{i} ( t ) \}}_{i = 1}^{{2}^{N}}$$

for conveying N bits information. Each of the plurality of functions

$${s}_{fb , unmod} = {\{ {s}_{i} ( t ) \}}_{i = 1}^{{2}^{N}}$$

is defined based on a symbol-level scrambling with TXSeN_{ID}, RXSeN_{ID} and SeS_{ID}.

If the symbol-level scrambling is applied in a hopping scenario, in some embodiments, s_{fb,unmod} (t) is a concatenation of L time domain functions, and can be written as

$${s}_{fb , unmod} ( t ) = [ {s}_{fb , unmod}^{( 1 )} ( t ) , {s}_{fb , unmod}^{( 2 )} ( t ) , … , {s}_{fb , unmod}^{( L )} ( t ) ] ,$$

$$where$$

$${s}_{fb , unmod}^{( k )} ( t ) = {g}_{a , unmod}^{( k )} ( {TXSeN}_{ID} , {SeS}_{ID} , {RXSeN}_{ID} ) ,$$

and L donates a hopping parameter.

In some embodiments, the symbol-level scrambling can be applied to each of

$${s}_{fb , unmod}^{( k )} ( t ) ,$$

$$k = 1 , … , L .$$

For example,

$${s}_{fb , unmod}^{( k )} ( t ) = {λ}_{{TXSeN}_{ID}}^{( k )} ( t ) {λ}_{{SeS}_{ID}}^{( k )} ( t ) {λ}_{{RXSeN}_{ID}}^{( k )} ( t ) ,$$

$$k = 1 , … , L .$$

For cases that the sensing feedback content SeN_{fb} is analog, in a hopping scenario, s_{fb}(t) can be written as

$$[ {η}_{1} ( {SeN}_{fb} ) {s}_{fb , unmod}^{( 1 )} ( t ) , {η}_{2} ( {SeN}_{fb} ) {s}_{fb , unmod}^{( 2 )} ( t ) , … , {η}_{L} ( {SeN}_{fb} ) {s}_{fb , unmod}^{( L )} ( t ) ] .$$

For cases where the sensing feedback content SeN_{fb} is discrete, in a hopping scenario, in some embodiments, SeN_{fb} is gone through the FEC before the modulation or the selection. The coded bits SeN_{fb,coded} may be divided into L sequences with a length NIL. Each sequence of the L sequences is used to modulate or select one of the L time domain functions which are included in s_{fb,unmod}(t).

In the case of analog-domain sensing feedback codebook, the sensing feedback configuration may include at least one of the following information: a hopping parameter L, at least one scrambling function, or at least one second function. In cases of L=1, there would be no hopping. The at least one scrambling function is in one-to-one correspondence with the at least one sensing-related ID. Each scrambling function is used to convert a corresponding ID into a time domain function. The at least one scrambling function can be written as

$${λ}_{{TXSeN}_{ID}}^{( k )} ( t ) ,$$

$${λ}_{{SeS}_{ID}}^{( k )} ( t ) ,$$

$${λ}_{{RXSeN}_{ID}}^{( k )} ( t ) ,$$

k=1, . . . , L. If the feedback signal is configured not to include any of TXSeN_{ID}, RXSeN_{ID}, and SeS_{ID}, for any given hopping index k, the scrambling function corresponding to that particular ID can be set to 1, i.e.

$${λ}_{{X}_{ID}}^{( k )} ( t ) = 1.$$

The second function is used to process the sensing feedback content. The at least one second function can be ηₖ(SeN_{fb}), k=1, . . . , L, for each hopping index k.

As an example of analog-domain sensing feedback, a chirp-based sensing feedback signal is described below.

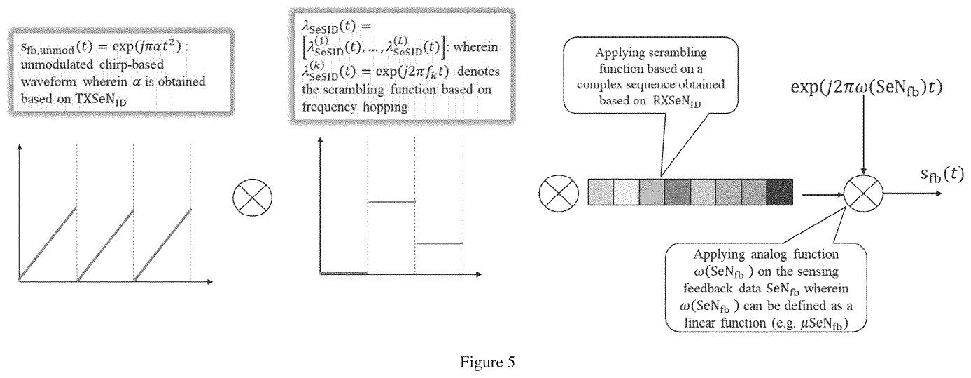

FIG. 5 is an example of a Chirp-based sensing feedback signal design. A chirp-based signal may also be known as a linear frequency modulated (LFM) signal.

With reference to FIG. 5, an unmodulated unscrambled feedback signal, denoted by s₀(t), is first obtained based on an LFM signal exp(jπαt²). Chirp slope a can be mapped to TXSeN_{ID}. One advantage of such design would be that all feedback signals sent to TXSeN_{ID} have a same chirp slope, which has been shown to reduce the receiver complexity.

Next step would be to apply the scrambling functions related to SeS_{ID} and RXSeN_{ID}. The former can be obtained based on frequency hopping, i.e.

$${λ}_{{SeS}_{ID}} ( t ) = [ {λ}_{{SeS}_{ID}}^{( 1 )} ( t ) , … , {λ}_{{SeS}_{ID}}^{( L )} ( t ) ]$$

$$where$$

$${λ}_{{SeS}_{ID}}^{( k )} ( t ) = exp ( {j 2 π f}_{k} t ) ,$$

k=1, . . . , L. This gives the unmodulated feedback signal s_{fb,unmod}(t) as s_{fb,unmod}(t)=exp(jπαt²) λ_{SeS}_{_{ID}} (t)λ_{RXSeN}_{_{ID}} (t). The latter can be obtained based on a complex sequence obtained based on RXSeN_{ID}.

Finally, the feedback signal is obtained based on modulating s_{fb,unmod}(t) by using an exponential function exp(j2πω(SeN_{fb})t), where the frequency ω(SeN_{f}.) is mapped to the sensing feedback content through a linear mapping, i.e. ω(SeN_{fb})=μSeN_{fb}.

At Step 404, the node that received the feedback signal determines the sensing feedback content by de-scrambling the feedback signal based on the at least one ID.

For example, the at least one ID is sensing-related and includes at least one of RXSeN_{ID}, TXSeN_{ID} or SeS_{ID}.

FIG. 4 shows an example that the second sensing node receives the feedback signal.

Procedures at the second sensing node for determining the sensing feedback content correspond to procedures at the first sensing node.

In the scenario 1, the second sensing node may convert the at least one identity into at least one scrambling sequence which is in one-to-one correspondence with the at least one sensing-related ID, de-scramble the feedback signal based on the at least one scrambling sequence to obtain the sensing feedback codeword, and obtain the sensing feedback content based on the sensing feedback codeword.

In an example of embedding TXSeN_{ID}, RXSeN_{ID} and SeS_{ID} to the feedback signal, a formula expression of the above way of de-scrambling is provided below.

At the second sensing node, after receiving the sensing signal from the first sensing node, the second sensing node first tries to detect s_{fb} which is denoted as s_{fb}. Then, the second sensing node de-scrambles s_{fb} to produce [symbol] =\tilde{s}_{fb}⊕σ₁(TXSeN_{ID})⊕σ₂ (SeS_{ID})⊕σ₃(RXSeN_{ID}).

Then, [symbol] may be fed into a FEC decoder to generate [symbol] . Because TXSeN_{ID} and SeS_{ID} are known at the second sensing node, σ₁(TXSeN_{ID}) and σ₂(SeS_{ID}) are already known. The second sensing node needs to try all potential values of RXSeN_{ID}, which are configured to nodes that need to send feedback signals to the second sensing node. The second sensing node tries to decode [symbol] by using each of the potential values of RXSeN_{ID}. Only the true value of RXSeN_{ID} may result in a legitimate FEC decoder output (e.g. a cyclic redundancy check (CRC) is passed). For any of the IDs that are different from the true value, the FEC decoder to [symbol] may not generate a legitimate FEC decoder output. In this way, unwanted feedback signals can be filtered out.

In the scenario 2, for cases where the sensing feedback content is in digital format or in analog format, in some embodiments, the second sensing node may generate an unmodulated waveform based on the first function which is defined based on a symbol-level scrambling with the at least one sensing-related ID, de-modulate the feedback signal based on the unmodulated waveform to obtain the sensing feedback codeword, and obtain the sensing feedback content based on the sensing feedback codeword. The way of generating the unmodulated waveform based on the first function by the second sensing node is the same as that the first sensing node generates the unmodulated waveform based on the first function and will not be repeated here.

In the scenario 2, for cases where the sensing feedback content is in discrete format or in analog format, in some embodiments, the second sensing node may first apply

$$r ( t ) = {s}_{Rx , eq} ( t ) {λ}_{{SeS}_{ID}}^{*} ( t ) exp ( - {j πα t}^{2} )$$

where s_{Rx}(t) denotes a received feedback signal from the first sensing node,

$${λ}_{{SeS}_{ID}} ( t ) = [ {λ}_{{SeS}_{ID}}^{( 1 )} ( t ) , … , {λ}_{{SeS}_{ID}}^{( L )} ( t ) ]$$

$$where$$

$${λ}_{{SeS}_{ID}}^{( k )} ( t ) = exp ( {j 2 π f}_{k} t ) ,$$

k=1, . . . , L and (.)* denotes a complex conjugate operation. The rationale behind this is to compensate for the scrambling functions related to SeS_{ID} and TXSeN_{ID}. SeS_{ID} and TXSeN_{ID} are already known by the second sensing node. Then, the second sensing node applies

$${λ}_{{RXSeN}_{ID}}^{*} ( t )$$

on r(t) for all potential values of RXSeN_{ID}, and then applies a sampling and a FFT to obtain SeN_{fb} (i.e. the sensing feedback content) by observing a peak in an output of the FFT. The output of the FFT corresponding to a right RXSeN_{ID} produces the largest peak and this output can be used to obtain ω(SeN_{f}) based on a location of the largest peak. And then ω(SeN_{fb}) is converted to SeN_{fb} based on an inverse analog mapping function. For example, in a case of a linear mapping ω(SeN_{fb})=μSeN_{fb}, we get

$${SeN}_{fb} = \frac{1}{μ} ω ( {SeN}_{fb} ) .$$

Since there is a wireless propagation channel between the second sensing node and the first sensing node, the second sensing node may first equalize the received feedback signal s_{Rx}(t) to remove an effect of propagation delay(s) corresponding to a multi-path channel and then perform the operation above, i.e.

$$r ( t ) = {s}_{Rx , eq} ( t ) {λ}_{{SeS}_{ID}}^{*} ( t ) exp ( - {j πα t}^{2} ) ,$$

where s_{Rx,eq}(t) denotes an equalized version of the received signal. In some embodiments where the channel is a single path with delay τ, s_{Rx,eq}(t) can be obtained based on s_{Rx,eq}(t)=s_{Rx}(t+Σ).

In some embodiments, the second sensing node can first estimate parameters of the wireless propagation channel to be used for equalizing the received feedback signal. In some embodiments, estimating the parameters of the wireless propagation channel can be performed based on a pilot signal sent by the first sensing node, before a transmission of the feedback signal. In some embodiments, if the feedback signal is included in L symbols, the first symbol may include the pilot signal. In some embodiments, the pilot signal may include an LFM signal exp(jπαt²) where α is mapped to TXSeN_{ID} which is known at the second sensing node.

Thus, in method 400, the at least one sensing-related ID can be embedded into the feedback signal by scrambling. The scrambling enables efficient separation of sensing feedback signals without increasing the sensing feedback payload size.

It should be noted that the above embodiments of this application may be implemented independently or together in an appropriate way.

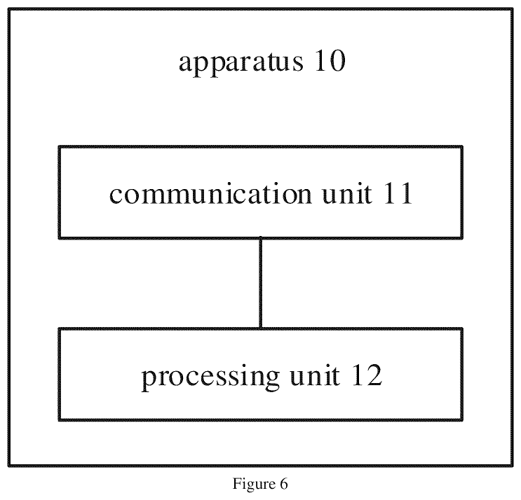

The method provided in this application is described in detail above in conjunction with FIGS. 1 to 5. The apparatus embodiments of this application will be described in detail below in conjunction with FIG. 6 to FIG. 8.

It is understood that in order to implement the functions in the above embodiments, the apparatus in FIG. 6 to FIG. 8 may include the corresponding hardware architecture and/or software modules that perform each of the functions.

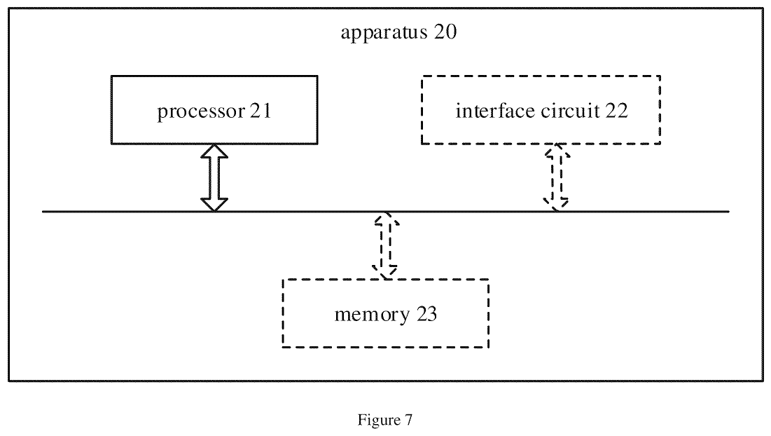

FIG. 6 and FIG. 7 provide possible structural diagrams of the apparatus. The apparatus may be used to implement the functions of the first sensing node or the second sensing node of the method embodiments described above, and thus the apparatus is able to achieve the beneficial effects of the method embodiments described above.

As shown in FIG. 6, an apparatus 10 includes a communication unit 11 and a processing unit 12.

When the apparatus 10 is used to implement the functions of the first sensing node in the method embodiments described above, the communication unit 11 is used for performing the sending and receiving steps, such as Step 401 and Step 403, and the processing unit 12 is used for performing the processing steps, such as Step 402.

When the apparatus 10 is used to implement the functions of the second sensing node in the method embodiments described above, the communication unit 11 is used for performing the sending and receiving steps, such as Step 401 and Step 403, and the processing unit 12 is used for performing the processing steps, such as Step 404.

More detailed descriptions of the communication unit 11 and the processing unit 12 may refer to the relevant descriptions in the method embodiments described above, and not be repeated here.

As shown in FIG. 7, an apparatus 20 may include a processor 21. The processor 21 is coupled to a memory 23 which is used to store instructions. While the apparatus 20 is used to implement the method described above, the processor 21 is used to execute the instructions in the memory 23 to implement the functions of the processing unit 12 described above.

Optionally, the apparatus 20 further includes the memory 23.

Optionally, the apparatus 20 further includes an interface circuit 22. The processor 21 is coupled to the interface circuit 22. Understandably, the interface circuit 22 may be a transceiver or I/O interface. When the apparatus 20 is used to implement the method described above, the processor 21 is used to execute the instructions to implement the functions of the processing unit 12 and the interface circuit 22 is used to implement the functions of the communication unit 11.

Illustratively, when the apparatus 20 is an integrated circuit implemented at the first sensing node or the second sensing node, the integrated circuit implements the function of the first sensing node or the second sensing node. The integrated circuit receives information from other modules (such as a radio frequency module or an antenna) in the first sensing node or the second sensing node, and the information is sent to the first sensing node or the second sensing node by another device. Optionally, the integrated circuit sends information to other modules (such as a radio frequency module or an antenna) in the first sensing node or the second sensing node, and the information is sent to another device.

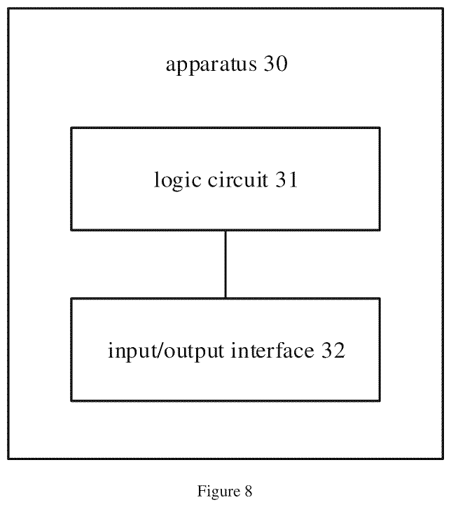

FIG. 8 represents a schematic illustration of an apparatus 30 provided by the embodiments of this application. The apparatus 30 (alternatively, the processing system) includes a logic circuit 31 and an input/output interface 32.

The logic circuit 31 can be the processing circuit in the apparatus 30. The logic circuit 31 can be coupled to a storage unit and call instructions in the storage unit, so that the apparatus 30 can realize the methods and functions of each embodiment of the application.

The input/output interface 32 can be the input and output circuit in the apparatus 30 to output the information processed by the apparatus 30, or to input the data or signaling information to be processed into the apparatus 30 for processing.

As a scheme, the apparatus 30 is used to implement the operations performed by the first sensing node or the second sensing node in the method embodiments above.

For example, a logic circuit 31 is used to implement the process-related operations performed by the first sensing node or the second sensing node in the method embodiments above. The input/output interface 32 is used to implement the transmit and/or receive related operations performed by the first sensing node or the second sensing node in the method embodiments above.

The embodiments of the application also provide an apparatus for sensing, which includes one or more processors, where the one or more processors are configured to execute a computer program or instructions stored in a memory to implement any of the methods provided by the above-mentioned method embodiments.

The embodiments of the application also provide a processor which is configured to execute a computer program or instructions stored in a memory to implement any of the methods provided by the above-mentioned method embodiments.

The embodiments of the application also provide a computer-readable medium on which a program or instructions are recorded, where the program or the instructions, when executed, enables a computer to implement any of the methods provided by the above-mentioned method embodiments.

The embodiments of the application also provide a computer program product, where the computer program product includes instructions to implement any of the methods provided by the above-mentioned method embodiments.

The embodiments of the application also provide a computer program, where the computer program, when executed, enables a computer to implement any of the methods provided by the above-mentioned method embodiments.

The embodiments of the application also provide an apparatus including at least one processor and a communication interface, where the at least one processor is used to obtain a computer program or instructions stored in a memory through the communication interface to implement any of the methods provided by the above-mentioned method embodiments.

The embodiments of the application also provide a communication system, where the communication system includes the first sensing node and/or the second sensing node mentioned above.

In the embodiments of this application, “and/or” describes an association relationship between associated objects and represents that three relationships may exist. For example, A and/or B may represent the following three cases: Only A exists, both A and B exist, and only B exists. The character “/” generally indicates an “or” relationship between the associated objects. “Multiple A” means two or more A. “At least one” means one or more. “At least one of A and B,” similar to “A and/or B,” describes an association relationship between associated objects and represents that three relationships may exist. For example, at least one of A and B may represent the following three cases: only A exists, both A and B exist, and only B exists.

Besides, the use of a singular form of “a,” “an,” and “the” in the embodiments of the present application and the claims appended hereto is also intended to include a plural form, unless otherwise clearly indicated herein by context.

A person of ordinary skill in the art will be aware that, in combination with the examples described in the embodiments disclosed in this specification, units and algorithm steps may be implemented by using electronic hardware or a combination of computer software and electronic hardware. Whether the functions are performed by using hardware or software depends on particular applications and design constraint conditions of the technical solutions. A person skilled in the art may use different methods to implement the described functions for each particular application, but it should not be considered that the embodiment goes beyond the scope of this application.

It would be understood by a person skilled in the art that, for the purpose of convenience and brevity, in a detailed working process of the foregoing system, apparatus, and unit, reference may be made to a corresponding process in the foregoing method embodiments, and details are not described herein again.

In the several embodiments provided in this application, the disclosed system, apparatus, and method may be implemented in other manners. For example, the described apparatus embodiment is merely an example. For example, the unit division is a logical function division and other methods of division may be used in an actual embodiment. For example, a plurality of units or components may be combined or integrated into another system, or some features may be ignored or not performed. In addition, the displayed or discussed mutual couplings or direct couplings or communication connections may be implemented using various communication interfaces. The indirect couplings or communication connections between the apparatuses or units may be implemented in electronic, mechanical, or other forms.

In addition, function units in the embodiments of this application may be integrated into one processing unit, each of the units may exist alone physically, or two or more units may be integrated into one unit.

When the functions are implemented in the form of a software functional unit and sold or used as an independent product, the functions may be stored in a computer-readable storage medium. The technical solutions of this application may be implemented in the form of a software product. The software product is stored in a storage medium, and includes several instructions for instructing a computer device (which may be a personal computer, a server, a network device, or the like) to perform all or some of the steps of the methods described in the embodiments of this application. The foregoing storage medium includes any medium that can store program code, such as a USB flash drive, a removable hard disk, a ROM, a RAM, a magnetic disk, an optical disc or the like.

The units described as separate parts may be or may not be physically separate, and parts displayed as units may be or may not be physical units, may be located in one position, or may be distributed on a plurality of network units. Some or all of the units may be selected based on actual requirements to achieve the objectives of the solutions of the embodiments. In addition, functional units in the embodiments of this application may be integrated into one processing unit, or each of the units may exist alone physically, or two or more units are integrated into one unit.

The foregoing descriptions are merely specific embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A method comprising:
receiving, by a first sensing node, a sensing feedback configuration from a second sensing node or another node responsible for coordinating sensing activities, wherein the sensing feedback configuration is used to generate a feedback signal;
receiving, by the first sensing node, a sensing signal from the second sensing node;
estimating, by the first sensing node, sensing parameters based on the sensing signal, wherein the sensing parameters indicate properties of a sensing target;
generating, by the first sensing node, the feedback signal based on the sensing feedback configuration and the sensing parameters, wherein the feedback signal carries a sensing feedback content which indicates the sensing parameters, at least one identity is embedded in the feedback signal by scrambling; and
transmitting, by the first sensing node, the feedback signal.

2. The method of claim 1, wherein the at least one identity comprises at least one of: an identity of the first sensing node, an identity of the second sensing node, or an identity of a sensing session for estimating the sensing parameters.

3. The method of claim 1, wherein the sensing feedback configuration indicates a first mapping between a sensing feedback codeword and the at least one identity, the sensing feedback codeword carries the sensing feedback content, and the feedback signal is based on the sensing feedback codeword.

4. The method of claim 1, wherein the generating the feedback signal based on the sensing feedback configuration and the sensing parameters comprises:
converting, by the first sensing node, the at least one identity into at least one scrambling sequence, wherein the at least one scrambling sequence is in a one-to-one correspondence with the at least one identity;
obtaining, by the first sensing node, the sensing feedback content based on the sensing parameters;
scrambling, by the first sensing node, the sensing feedback content with the at least one scrambling sequence to obtain a sensing feedback codeword; and
generating, by the first sensing node, the feedback signal based on the sensing feedback codeword.

5. The method of claim 1, wherein the generating the feedback signal based on the sensing feedback configuration and the sensing parameters comprises:
generating, by the first sensing node, an unmodulated waveform based on a first function, wherein the first function is defined based on a symbol-level scrambling with the at least one identity;
obtaining, by the first sensing node, the sensing feedback content based on the sensing parameters;
modulating, by the first sensing node, the unmodulated waveform based on the sensing feedback content to obtain a sensing feedback codeword; and
generating, by the first sensing node, the feedback signal based on the sensing feedback codeword.

6. A method comprising:
transmitting, by a second sensing node, a sensing signal to a first sensing node to sense a sensing target;
receiving, by the second sensing node, a feedback signal, wherein the feedback signal carries a sensing feedback content which indicates sensing parameters, the sensing parameters indicate properties of the sensing target; and
determining, by the second sensing node, the sensing feedback content by de-scrambling the feedback signal based on at least one identity.

7. The method of claim 6, wherein the at least one identity comprises at least one of: an identity of the first sensing node, an identity of the second sensing node, or an identity of a sensing session for estimating the sensing parameters.

8. The method of claim 6, wherein the method further comprises:
transmitting, by the second sensing node, a sensing feedback configuration to the first sensing node, wherein the sensing feedback configuration is used to generate the feedback signal and indicates a first mapping between a sensing feedback codeword and the at least one identity, the sensing feedback codeword carries the sensing feedback content, and the feedback signal is based on the sensing feedback codeword.

9. The method of claim 6, wherein the determining the sensing feedback content by de-scrambling the feedback signal based on the at least one identity comprises:
converting, by the second sensing node, the at least one identity into at least one scrambling sequence, wherein the at least one scrambling sequence is in a one-to-one correspondence with the at least one identity;
de-scrambling, by the second sensing node, the feedback signal based on the at least one scrambling sequence to obtain a sensing feedback codeword; and
obtaining, by the second sensing node, the sensing feedback content based on the sensing feedback codeword.

10. The method of claim 6, wherein the determining the sensing feedback content by de-scrambling the feedback signal based on the at least one identity comprises:
generating, by the second sensing node, an unmodulated waveform based on a first function, wherein the first function is defined based on symbol-level scrambling with the at least one identity;
de-modulating, by the second sensing node, the feedback signal based on the unmodulated waveform to obtain a sensing feedback codeword; and
obtaining, by the second sensing node, the sensing feedback content based on the sensing feedback codeword.

11. An apparatus at a first sensing node, the apparatus comprising:
at least one processor; and
a memory coupled to the at least one processor, the memory for storing instructions that, when executed by the at least one processor, cause the apparatus to perform:
receiving a sensing feedback configuration from a second sensing node or another node responsible for coordinating sensing activities, wherein the sensing feedback configuration is used to generate a feedback signal;
receiving a sensing signal from the second sensing node;
estimating sensing parameters based on the sensing signal, wherein the sensing parameters indicate properties of a sensing target;
generating the feedback signal based on the sensing feedback configuration and the sensing parameters, wherein the feedback signal carries a sensing feedback content which indicates the sensing parameters, at least one identity is embedded in the feedback signal by scrambling; and
transmitting the feedback signal.

12. The apparatus of claim 11, wherein the at least one identity comprises at least one of: an identity of the first sensing node, an identity of the second sensing node, or an identity of a sensing session for estimating the sensing parameters.

13. The apparatus of claim 11, wherein the sensing feedback configuration indicates a first mapping between a sensing feedback codeword and the at least one identity, the sensing feedback codeword carries the sensing feedback content, and the feedback signal is based on the sensing feedback codeword.

14. The apparatus of claim 11, wherein the generating the feedback signal based on the sensing feedback configuration and the sensing parameters comprises:
converting the at least one identity into at least one scrambling sequence, wherein the at least one scrambling sequence is in a one-to-one correspondence with the at least one identity;
obtaining the sensing feedback content based on the sensing parameters;
scrambling the sensing feedback content with the at least one scrambling sequence to obtain a sensing feedback codeword; and
generating the feedback signal based on the sensing feedback codeword.

15. The apparatus of claim 11, wherein the generating the feedback signal based on the sensing feedback configuration and the sensing parameters comprises:
generating an unmodulated waveform based on a first function, wherein the first function is defined based on a symbol-level scrambling with the at least one identity;
obtaining the sensing feedback content based on the sensing parameters;
modulating the unmodulated waveform based on the sensing feedback content to obtain a sensing feedback codeword; and
generating the feedback signal based on the sensing feedback codeword.

16. An apparatus at a second sensing node, the apparatus comprising:
at least one processor; and
a memory coupled to the at least one processor, the memory for storing instructions that, when executed by the at least one processor, cause the apparatus to perform:
transmitting a sensing signal to a first sensing node to sense a sensing target;
receiving a feedback signal, wherein the feedback signal carries a sensing feedback content which indicates sensing parameters, the sensing parameters indicate properties of the sensing target; and
determining the sensing feedback content by de-scrambling the feedback signal based on at least one identity.

17. The apparatus of claim 16, wherein the at least one identity comprises at least one of: an identity of the first sensing node, an identity of the second sensing node, or an identity of a sensing session for estimating the sensing parameters.

18. The apparatus of claim 16, wherein the instructions further cause the apparatus to perform:
transmitting a sensing feedback configuration to the first sensing node, wherein the sensing feedback configuration is used to generate the feedback signal and indicates a first mapping between a sensing feedback codeword and the at least one identity, the sensing feedback codeword carries the sensing feedback content, and the feedback signal is based on the sensing feedback codeword.

19. The apparatus of claim 16, wherein the determining the sensing feedback content by de-scrambling the feedback signal based on the at least one identity comprises:
converting the at least one identity into at least one scrambling sequence, wherein the at least one scrambling sequence is in q one-to-one correspondence with the at least one identity;
de-scrambling the feedback signal based on the at least one scrambling sequence to obtain a sensing feedback codeword; and
obtaining the sensing feedback content based on the sensing feedback codeword.

20. The apparatus of claim 16, wherein the determining the sensing feedback content by de-scrambling the feedback signal based on the at least one identity comprises:
generating an unmodulated waveform based on a first function, wherein the first function is defined based on symbol-level scrambling with the at least one identity;
de-modulating the feedback signal based on the unmodulated waveform to obtain a sensing feedback codeword; and
obtaining the sensing feedback content based on the sensing feedback codeword.
